(19) United States
(12) Patent Application Publication
(10) Pub. No.: US 2013/0056236 A1
(43) Pub. Date: Mar. 7, 2013

(54) THRED FASTENER TIGHTENING AND LOOSENING DEVICE

(71) Applicants: Satoshi Morinishi, Ayabe (JP); Masayuki Saito, Ayabe (JP)

(72) Inventors: Satoshi Morinishi, Ayabe (JP); Masayuki Saito, Ayabe (JP)

(21) Appl. No.: 13/261,303

(22) PCT Filed: Dec. 13, 2010
(86) PCT No.: PCT/JP10/72396

§ 371 Date: Nov. 9, 2012

(30) Foreign Application Priority Data
Dec. 17, 2009 (JP) 2009-286405
Dec. 10, 2010 (JP) 2010-276240

(51) Int. Cl. B25B 23/14

(52) U.S. Cl. 173/176

(57) ABSTRACT

An object of the present invention is to provide a threaded fastener tightening and loosening device capable of achieving operations of both tightening and loosening a threaded fastener at high speed and with high torque precision by means of a single rotation drive source. A first input shaft (5) which is rotated by being driven by an AC servo motor (3) is provided. A second input shaft (9) is connected to the first input shaft (5) via an electromagnetic clutch (8). An output shaft (11) to which a threaded fastener tightening tool is connected is provided. The second input shaft (9) is connected to the output shaft (11) while the first input shaft (5) is connected via a speed reduction device (12) and a tool clutch (14). By controlling the clutches (8, 14) to meet a tightening process for the threaded fastener or a loosening process therefor, switch is made between a state where high speed low torque rotation is transmitted from the second input shaft (9) to the output shaft (11) and a state where low speed high torque rotation is transmitted from the first input shaft (5) to the output shaft (11) via the speed reduction device (12).

### TECHNICAL FIELD

The present invention relates to a threaded fastener tightening and loosening device which tightens or loosens a threaded fastener.

### BACKGROUND ART

In tightening a threaded fastener into a work, the shortening of the threaded fastener tightening cycle time, that is, the speeding-up of the threaded fastener tightening operation, is an important problem. To solve this, various threaded fastener tightening devices shown in Patent Documents 1 to 5 have been proposed.

The threaded fastener tightening devices disclosed in Patent Documents 1 to 4 each have two rotation drive sources of first driving means for rotatably driving a threaded fastener tightening tool at high speed and with low torque and second driving means for rotatably driving the threaded fastener tightening tool at low speed and with high torque. In the threaded fastener tightening device in Patent Document 1, at the time of driving the first driving means, the idling action of a one-way clutch is used so as not to be subjected to the speed reduction resistance of the second driving means. In addition, in the threaded fastener tightening devices in Patent Documents 2 to 4, the driving of the first driving means can be transmitted from an output shaft to the threaded fastener tightening tool by means of a belt, and the driving of the second driving means can be transmitted from the output shaft to the threaded fastener tightening tool by speed reduction and torque increase from a speed reduction device only when an electromagnetic clutch is coupled. According to the threaded fastener tightening devices in Patent Documents 1 to 4, a threaded fastener is temporarily tightened at high speed and with low torque until the threaded fastener is seated, and then, the threaded fastener can be tightened at low speed and with high torque to final target tightening torque. However, since the two rotation drive sources are necessary, the device, weight, and power consumption are increased.

Accordingly, in Patent Document 5, the threaded fastener tightening device which can make a switch between high speed low torque tightening and low speed high torque tightening by means of a single rotation drive source has been proposed. The threaded fastener tightening device in Patent Document 5 outputs an input from a driving motor to two systems in which the input passes through the speed reduction device and the input does not pass through the speed reduction device, and has a plurality of one-way clutches which are combined on the rotation transmission path. Therefore, a high speed low torque output which does not pass through the speed reduction device is transmitted to a drive shaft at the time of the forward rotation of the motor, and a low speed high torque output which passes through the speed reduction device is transmitted to the drive shaft at the time of the reverse rotation of the motor.

### PRIOR ART DOCUMENTS

### Patent Documents

Patent Document 1: JP 2004-283948 A
Patent Document 2: JP 2008-6560 A
Patent Document 3: JP 2009-160709 A
Patent Document 4: JP 2009-178823 A
Patent Document 5: JP 2008-114303 A

### SUMMARY OF THE INVENTION

### Problems to be Solved by the Invention

According to the threaded fastener tightening device in Patent Document 5, the operation of tightening the threaded fastener at high speed and with low torque until the threaded fastener is seated, thereby tightening the threaded fastener to target tightening torque at low speed and with high torque, can be realized by the single rotation drive source. However, in the threaded fastener tightening device, since the forward and reverse rotation driving of the rotation drive source is used for tightening the threaded fastener, the drive shaft cannot be reversely rotated. Therefore, when the fixing (biting) of the head of the threaded fastener and the threaded fastener tightening tool which is caused at the time of tightening the threaded fastener to the target tightening torque is released, the threaded fastener tightening tool cannot be reversely rotated. In addition, to respond to the loosening operation of the threaded fastener, reorganization of the tightening device such that the one-way clutch is reversed is necessary. Therefore, the threaded fastener tightening device is not applicable to a worksite in which the tightening operation and the loosening operation of the threaded fastener are mixed.

### Solutions to the Problems

The present invention has been made in view of the above problems, and an object of the present invention is to provide a threaded fastener tightening and loosening device capable of achieving operations of both tightening and loosening a threaded fastener at high speed and with high torque precision by means of a single rotation drive source. To achieve the object, the present invention provides a threaded fastener tightening and loosening device which has a first input shaft which is rotated by being driven by a rotation drive source, a second input shaft which is rotatably provided, first clutch means which makes a switch between a state where the driving of the rotation drive source can be transmitted to both the first input shaft and the second input shaft and a state where the driving of the rotation drive source cannot be transmitted to the second input shaft, a speed reduction device which is connected to the first input shaft and can speed-reduce and output the rotation of the first input shaft at a predetermined speed reduction ratio, an output shaft to which a threaded fastener tightening tool engageable with the head of a threaded fastener is connected and which is rotatable by being rotated by the second input shaft, second clutch means which makes a switch between a state where the output rotation of the speed reduction device can be transmitted to the output shaft and a state where the output rotation of the speed reduction device cannot be transmitted to the output shaft, and a control unit which controls the first clutch means and the second clutch means so that the rotation transmission state according to the first clutch means and the second clutch means becomes a predetermined rotation transmission state in each of a tightening process and a loosening process of the threaded fastener.

In addition, desirably, the control unit controls the first clutch to a state where the driving of the rotation drive source can be transmitted to the second input shaft and controls the second clutch to a state where the output rotation of the speed reduction device cannot be transmitted to the output shaft in the process of tightening the threaded fastener at high speed and in the process of loosening the threaded fastener at high speed. Also, desirably, the control unit controls the first clutch to a state where the driving of the rotation drive source cannot be transmitted to the second input shaft and controls the second clutch means to a state where the output rotation of the speed reduction device can be transmitted to the output shaft in the process of tightening the threaded fastener with high torque and in the process of loosening the threaded fastener with high torque.

Also, desirably, the control unit controls the rotation drive source to reduce the rotating speed of the output shaft to a predetermined rotating speed immediately before the threaded fastener is seated. Further, desirably, the control unit controls the rotation drive source to reduce the rotating speed of the output shaft stepwise and non-stepwise from the seating of the threaded fastener to the completion of tightening.

Also, desirably, the speed reduction device adopts a harmonic drive (registered trademark), the first input shaft is connected to a wave generator, and the second clutch means is provided so that an output from a flex spline is transmitted. Also, desirably, each of the first clutch means and the second clutch means is an electromagnetic clutch having an input portion and an output portion which can be coupled and decoupled by an electromagnetic force.

### Advantages of the Invention

By means of the single rotation drive source, the threaded fastener can be rotated at high speed and with low torque so as to be tightened at high speed until the threaded fastener is seated, and after seated, the threaded fastener can be rotated at low speed and with high torque so as to be tightened to predetermined tightening torque. Therefore, the tightening of the threaded fastener at high speed and with high precision is enabled. In addition, the threaded fastener which has already been tightened can be reliably loosened at low speed and with high torque while the torque is monitored, and after loosening torque is reduced, the threaded fastener can be loosened and removed at high speed and with low torque. Therefore, the loosening of the threaded fastener at high speed and with high precision is enabled. In this way, the output shaft can be freely rotated at a desired angle, at low speed and with high torque, and at high speed and with low torque in both the direction tightening the threaded fastener and the direction loosening the threaded fastener. Therefore, the operation of slightly reversely rotating the threaded fastener tightening tool fixed to the head of the threaded fastener by the tightening of the threaded fastener to release the fixing, which has been difficult, is enabled. Further, the above effect can be obtained by the motor which has a small rated output to the extent that temporary tightening torque is produced by impact torque caused when the threaded fastener is seated. Therefore, the threaded fastener tightening and loosening device with less power consumption can be realized; thereby contributing to energy saying.

Also, the control unit controls the rotation drive source to reduce the rotating speed of the output shaft to the predetermined rotating speed immediately before the threaded fastener is seated, so that the impact torque at the time of seating can be low. For this reason, the excessive tightening of the threaded fastener due to the impact torque can be prevented. Therefore, tightening can be precisely completed with the target tightening torque. Also, from the seating of the threaded fastener to the completion of tightening, the rotation drive source is controlled so as to reduce the rotating speed of the output shaft stepwise and non-stepwise, so that the threaded fastener can be prevented from being excessively tightened at the time of completing tightening. Therefore, tightening can be completed with the target tightening torque more precisely.

### BRIEF DESCRIPTION OF THE DRAWINGS

FIG. 1 is a cross-sectional view of a threaded fastener tightening and loosening device according to the present invention.

FIGS. 2(a) and 2(b) are operation explanatory views showing the schematic configuration of the threaded fastener tightening and loosening device according to the present invention.

FIGS. 3(a) and 3(b) are operation explanatory views showing the schematic configuration of the threaded fastener tightening and loosening device according to the present invention.

FIG. 4 is a graph showing the driving control of the threaded fastener tightening and loosening device according to the present invention.

FIG. 5 is a graph which compares the rotating speed of an output shaft with the magnitude of impact torque by speed reduction ratio.

### MODES FOR CARRYING OUT THE INVENTION

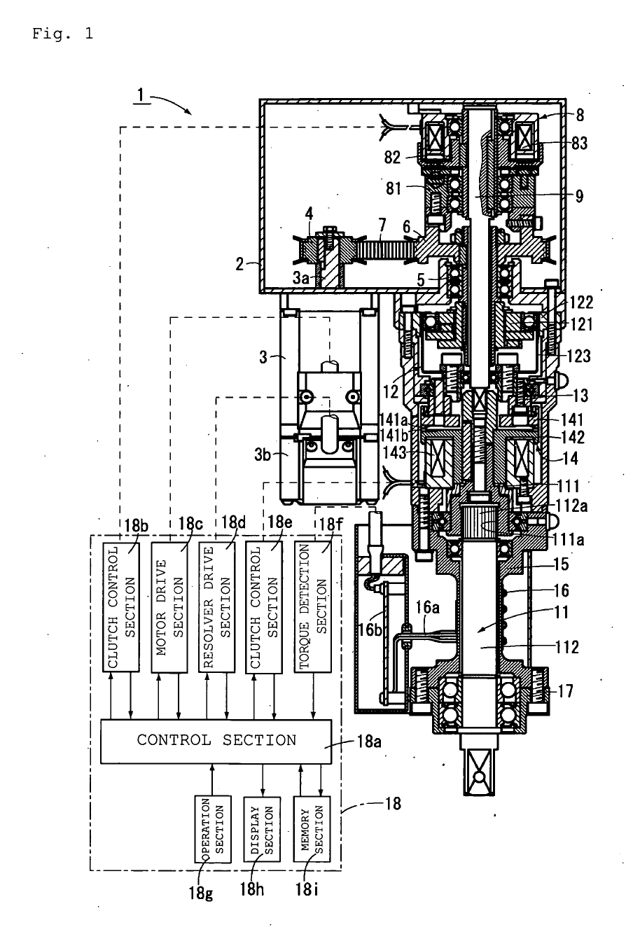

Hereinafter, an embodiment of the present invention will be described with reference to the drawings. In FIG. 1, reference numeral 1 denotes a threaded fastener tightening and loosening device for tightening or loosening a threaded fastener such as a screw, bolt, and nut, and having an AC servo motor 3 (hereinafter, simply called a motor 3) which is an example of a rotation drive source attached to a case 2. A resolver 3b is assembled into the motor 3 so as to detect the rotation angle of a drive shaft 3a of the motor 3.

A driving toothed pulley 4 (hereinafter, simply called a driving pulley 4) is integrally rotatably connected to the drive shaft 3a of the motor 3. A first input shaft 5 which has a hollow tubular shape and extends to be axially parallel with the drive shaft 3a is provided sideward of the motor 3 so as to be rotatably supported. A driven toothed pulley 6 (hereinafter, simply called a driven pulley 6) is integrally connected to the upper portion of the first input shaft 5. The driven pulley 6 and the driving pulley 4 around which an endless toothed belt 7 is wound are engaged with each other, so that the driving of the motor 3 can be transmitted to the first input shaft 5. Also, an electromagnetic clutch 8 is provided as an example of first clutch means to the upper portion of the driven pulley 6. A second input shaft 9 which is a solid shaft, is inserted through the first input shaft 5, and is provided rotatable with respect to the first input shaft 5 is connected to the electromagnetic clutch 8.

The electromagnetic clutch 8 has an input portion 81 which is integrally rotatably connected to the driven pulley 6, an output portion 82 which is integrally rotatably connected to the second input shaft 9, and a coil portion 83. The coil portion 83 becomes an electromagnet by electric current supply, so that the input portion 81 is connected to the output portion 82 by a magnetic force. At all times, no electric current is supplied to the coil portion 83, and the input portion 81 and the output portion 82 are disconnected, so that the driving of the motor 3 cannot be transmitted to the second input shaft 9. However, when an electric current is supplied to the coil portion 83 to connect the input portion 81 and the output portion 82, the driving of the motor 3 can be transmitted to the second input shaft 9.

The second input shaft 9 is inserted and extends into the first input shaft 5, and an output shaft 11 is connected to the end thereof. The output shaft 11 has a transmission shaft portion 111 which is connected to the second input shaft 9, and a body shaft portion 112 which is integrally rotatably connected to the transmission shaft portion 111 by inserting and engaging a spline shaft portion 112a into a spline hole portion 111a at the end of the transmission shaft portion 111. A threaded fastener tightening tool (not shown) such as a driver bit and a socket which is engaged with the head of the threaded fastener to transmit rotation thereto is connected to the end of the body shaft portion 112 of the output shaft 11 directly or via various joints.

Also, the end of the first input shaft 5 is connected to a speed reduction device 12. The speed reduction device 12 is typically known as a harmonic drive (registered trademark), and the first input shaft 5 is connected to a wave generator 121 thereof. The speed reduction device 12 adopts a typical used configuration as the so-called harmonic drive (registered trademark) speed reduction device in which a circular spline 122 is fixed to the case 2 of the threaded fastener tightening and loosening device 1 and a flex spline 123 speed-reduces and reverses rotation inputted from the wave generator 121. The speed reduction ratio is 1/30.

The flex spline 123 of the speed reduction device 12 is connected to a coupling 13 which has a hollow tubular shape and is rotatably arranged in the case 2. The coupling 13 is connected to a tooth clutch 14 which is an example of second clutch means. The tooth clutch 14 is an electromagnetic clutch which has an input portion 141 which is integrally rotatably connected to the coupling 13, an output portion 142 which is integrally rotatably connected to the transmission shaft portion 111 of the output shaft 11, biasing means (not shown) which biases the output portion 142 and the input portion 141 so as to disconnect the output portion 142 and the input portion 141 at all times, and a coil portion 143 fixed to the case 2. The input portion 141 and the output portion 142 have surfaces opposite to each other which are formed to be annular disc surfaces having teeth portions 141a and 142a formed at the peripheral edges thereof, and engage and connect the teeth portions 141a and 142a by an electromagnetic force produced by supplying an electric current to the coil portion 143. In the tooth clutch 14, the input portion 141 and the output portion 142 are disconnected without electric current supply to the coil portion 143 at all times, so that the output rotation of the speed reduction device 12 cannot be transmitted to the output shaft 11. However, when the input portion 141 and the output portion 142 are connected by supplying an electric current to the coil portion 143, the output rotation of the speed reduction device 12 can be transmitted to the output shaft 11.

Also, an elastic body 15 having a hollow tubular shape is integrally connected to the lower portion of the case 2. A strain gauge 16 is stuck onto the elastic body 15 to output an electric signal according to the strain amount of the elastic body 15. Also, an attaching flange 17 which can be fixed to the arm (not shown) and the frame (not shown) of a threaded fastener tightening robot is integrally fixed to the lower portion of the elastic body 15.

A control unit 18 has a control section 18a, a motor drive section 18c which receives an instruction from the control section 18a to driving control the motor 3, a resolver drive section 18d which applies an exciting voltage to the resolver 3b and calculates a rotation angle from the output voltage, a clutch control section 18b which receives an instruction from the control section 18a to electric current supply-control the electromagnetic clutch 8, a clutch control section 18e which receives an instruction from the control section 18a to electric current supply-control the tooth clutch 14, a memory section 18i which stores various programs and parameters necessary for the driving control of the motor 3, an operation section 18g which inputs various information, and a display section 18h which displays various information.

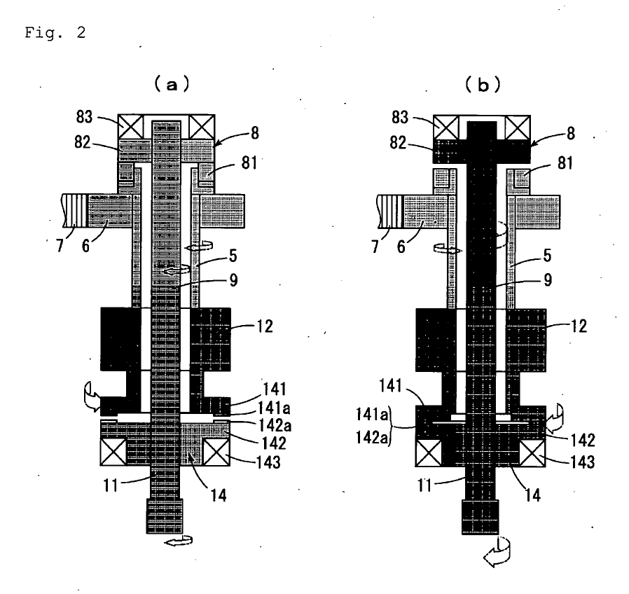

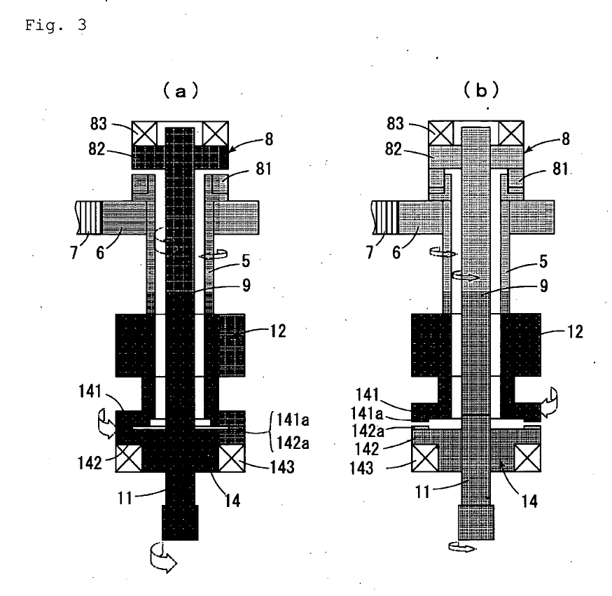

Next, the operation of the threaded fastener tightening and loosening device 1 will be described with reference to FIGS. 2(a) to 3(b). Here, the portions in gray color in FIGS. 2(a) to 3(b) indicate portions which are rotated by receiving rotation transmission in the respective states, and among them, the portions in dark gray color indicate portions which are rotated by receiving an output (speed-reduced and torque-increased rotation) from the speed reduction device 12. Also, each arrow in the drawings indicates the rotation direction of each of the portions.

The threaded fastener tightening and loosening device 1 performs the respective processes of “high speed tightening” for tightening the threaded fastener at high speed and with low torque from the start of threading to temporary tightening torque, “high torque tightening” for tightening the threaded fastener at low speed and with high torque from the temporary tightening torque to final target tightening torque, “high torque loosening” which loosens the threaded fastener which has already been tightened at low speed and with high torque to predetermined loosening torque, and “high speed loosening” which loosens and releases the threaded fastener at high speed and with low torque after the high torque loosening. Table 1 shows the driving states of the motor 3 and the rotation transmission states of the electromagnetic clutch 8 and the tooth clutch 14 in the respective processes. In Table 1, the term “ON” refers to a state where an electric current is supplied to the coil portion of each of the clutches to connect the input portion and the output portion, and the term “OFF” refers to a state where no electric current is supplied to the coil portion of each of the clutches to disconnect the input portion and the output portion.

TABLE 1

| | | Electromagnetic | Tooth |
|---|---|---|---|
| Process | Motor | clutch | clutch |
| High speed | Forward | ON | OFF |
| tightening | rotation | | |
| High torque | Reverse | OFF | ON |
| tightening | rotation | | |
| High torque | Forward | OFF | ON |
| loosening | rotation | | |
| High speed | Reverse | ON | OFF |
| loosening | rotation | | |

As shown in Table 1, in the “high speed tightening” process of the threaded fastener, the operation is performed with the motor 3 is forward rotation-driven, the electromagnetic clutch 8 is ON, and the tooth clutch 14 is OFF. As shown in FIG. 2(a), when the motor 3 is forward rotation-driven, the driving is transmitted to the driven pulley 6 by the driving pulley 4 and the toothed belt 7, thereby transmitting rotation to the first input shaft 5 and the electromagnetic clutch 8. At this time, the electromagnetic clutch 8 is ON, and the input portion 81 and the output portion 82 are integrally rotatable. This transmits rotation to the second input shaft 9, so that the second input shaft 9 is forwardly rotated together with the first input shaft 5.

The wave generator 121 is also forwardly rotated by the rotation of the first input shaft 5, and the flex spline 123 is speed reduction and torque increase-rotated in the reverse direction. At this time, the tooth clutch 14 is OFF, so that the speed reduction, torque increase, and reverse rotation output from the speed reduction device 12 are not further transmitted. In addition, the rotation of the second input shaft 9 is transmitted from the output shaft 11 to the threaded fastener tightening tool. In this way, the rotation transmission from the motor 3 to the output shaft 11 in a high speed tightening process is passed from the motor 3, the driving pulley 4, the driven pulley 6, the electromagnetic clutch 8, the second input shaft 9, and the output shaft 11 in that order. The forward rotation transmitted to the threaded fastener tightening tool is rotation at high speed and with low torque not via the speed reduction device 12, so that the threaded fastener can be threaded into a work at high speed. In this connection, the speed reduction ratio in the rotation transmission path is 1/2.4 which is defined according to the difference in diameter (the difference in the number of teeth) between the driving pulley 5 and the driven pulley 6.

Here, the elastic body 15 having a hollow tubular shape is integrally connected to the lower portion of the case 2. The bridge-connected strain gauge 16 is stuck onto the elastic body 15 so as to detect, as an analog signal, an electric signal according to the strain amount of the elastic body 15 strained according to tightening torque acting on the output shaft 11. The elastic body 15 and the strain gauge 16 configure torque detection means. In addition, a lead wire 16a of the strain gauge 16 is connected to a circuit board 16b, and digital-converts the analog signal on the circuit board 16b to output the digital signal to the torque detection section 18f. Then, the torque detection section 18f receives the digital signal from a CPU incorporated therein to perform the computing process, thereby electrically calculating the tightening torque acting on the output shaft 11.

When the threaded fastener is seated into the work, excessive tightening torque (hereinafter, called impact torque) which is over target tightening torque can instantly act on the threaded fastener by inertia. In such a case, the transmittable torque of the electromagnetic clutch 8 is set to be larger than the temporary tightening torque and smaller than the final tightening torque, so that the action of the impact torque causes sliding between the input portion 81 and the output portion 82. In addition, the motor 3 having small output torque may be previously selected so that the impact torque caused in the high speed tightening process is smaller than the target tightening torque. With these, the impact torque can be absorbed to, prevent the threaded fastener from being excessively tightened.

When the tightening torque is increased after seating to reach the temporary tightening torque, the routine goes to the “high torque tightening” process. As shown in Table 1, in a high torque tightening process, the motor 3 is reverse rotation-driven, the electromagnetic clutch 8 is OFF, and the tooth clutch 14 is ON. That is, the control unit 18 detects that the tightening torque reaches the temporary tightening torque, the driving of the motor 3 is switched to the reverse rotation driving, the electromagnetic clutch is OFF, and the tooth clutch 14 is ON.

As shown in FIG. 2(b), by the reverse rotation driving of the motor 3, rotation outputted from the speed reduction device 12 is forward rotation, so that the rotation is transmitted from the output shaft 11 to the threaded fastener tightening tool via the tooth clutch 14. At this time, the electromagnetic clutch 8 is OFF, so that the driving of the motor 3 is not transmitted to the second input shaft 9 therethrough. Therefore, the rotation transmission to the output shaft 11 is passed from the motor 3, the driving pulley 4, the driven pulley 6, the first input shaft 5, the speed reduction device 12, the tooth clutch 14, and the output shaft 11 in that order. Thereby, the output shaft 11 to the threaded fastener tightening tool are forwardly rotated at low speed and with high torque outputted from the speed reduction device 12. Therefore, the threaded fastener can be reliably tightened to the target tightening torque, and over running (excessive tightening) from the detection of the target tightening torque by the control unit 18 to the stop of the driving of the motor 3 can be prevented.

When the control unit 18 detects that the tightening torque reaches the target tightening torque, the threaded fastener tightening tool and the head of the threaded fastener fixed by tightening the threaded fastener are separated. This performs the “high torque loosening” process for a slight time. In this case, as shown in Table 1, the driving of the motor 3 is switched to the forward rotation driving, but the electromagnetic clutch 8 is OFF, and the tooth clutch 14 is ON.

Since the motor 3 is forward rotation-driven and the tooth clutch 14 is ON, as shown in FIG. 3(a), rotation at low speed and with high torque converted to reverse rotation by the speed reduction device 12 is transmitted from the output shaft 11 to the threaded fastener tightening tool. At this time, the electromagnetic clutch 8 is OFF, so that the driving of the motor 3 is not transmitted to the second input shaft 9 therethrough. Therefore, the threaded fastener tightening tool is reversely rotated at low speed and with high torque, and is reliably separated from the head of the threaded fastener fixed by tightening the threaded fastener. The forward rotation driving time of the motor 3 at this time is set to the extent that the threaded fastener tightening tool can be reversely rotated by a slight angle necessary for releasing the fixing; therefore, the threaded fastener cannot be loosened.

On the other hand, to loosen the threaded fastener which has already been tightened into the work, first, the “high torque loosening” process is performed in a state where the threaded fastener tightening tool is engaged with the head of the threaded fastener. The state of the motor 3, the electromagnetic clutch 8, and the tooth clutch 14 is the same as the state that the fixing of the threaded fastener and the threaded fastener tightening tool is released, so that the threaded fastener tightening tool is reversely rotated at low speed and with high torque to loosen the threaded fastener (see FIG. 3(a)). At this time, like the tightening torque, loosening torque is computed from the signal of the strain gauge 16 and is monitored by the control unit 18.

When the loosening torque is reduced to the predetermined torque, e.g., the torque which cannot cause sliding between the input portion 81 and the output portion 82 of the electromagnetic clutch 8, the “high speed loosening” process is then performed. As shown in Table 1, in a high speed loosening process, the motor 3 is reverse rotation-driven, the electromagnetic clutch 8 is ON, and the tooth clutch 14 is OFF. Thereby, as shown in FIG. 3(b), the threaded fastener tightening tool can be reversely rotated at high speed and with low torque, reversely from the high speed tightening process, so that the threaded fastener loosened to the predetermined loosening torque can be loosened and released at high speed in a high torque loosening process.

As described above, when the threaded fastener is tightened into the work, the threaded fastener tightening and loosening device 1 can thread the threaded fastener at high speed and with low torque until the tightening torque reaches the temporary tightening torque, and from this, can tighten the threaded fastener at low speed and with high torque to the target tightening torque. In addition, when the threaded fastener is loosened, the threaded fastener tightening and loosening device 1 can loosen the threaded fastener at low speed and with high torque to the predetermined loosening torque, and from this, can loosen and release the threaded fastener at high speed and with low torque. Therefore, both the reduction of the cycle time necessary for tightening or loosening the threaded fastener and the control of the tightening torque and the loosening torque with high precision are enabled. Further, in the threaded fastener tightening and loosening device 1, even when the rated output of the motor 3 is small, the temporary tightening torque at the time of tightening can be produced by using the impact torque, and the target tightening torque and the torque necessary for loosening the threaded fastener can be produced by using the speed reduction device 12. Therefore, the power consumption of the motor 3 is reduced to contribute to energy saving.

As the speed reduction device 12, other speed reduction mechanisms such as a planetary gear mechanism may be adopted. A speed reduction device in which outputted rotation is in the same direction as inputted rotation may be used. For instance, it is considered that the speed reduction device which outputs rotation in the same direction as rotation transmitted from the first input shaft 5 by the above configuration is used. Table 2 shows the driving states of the motor 3 and the rotation transmission states of the electromagnetic clutch 8 and the tooth clutch 14 in that case in the respective processes.

TABLE 2

| | | Electromagnetic | Tooth |
|---|---|---|---|
| Process | Motor | clutch | clutch |
| High speed | Forward | ON | OFF |
| tightening | rotation | | |
| High torque | Forward | OFF | ON |
| tightening | rotation | | |
| High torque | Reverse | OFF | ON |
| loosening | rotation | | |
| High speed | Reverse | ON | OFF |
| loosening | rotation | | |

As shown in Table 2, both the processes of the high speed tightening and the high speed loosening of the threaded fastener are the same as the above operations. In addition, in the high torque tightening and the high torque loosening of the threaded fastener, the motor 3 is simply driven reversely from the above description. That is, the motor 3 should be forward rotation-driven in the high torque tightening process, and the motor 3 should be reverse rotation-driven in the high torque loosening process. Even when such a speed reduction device is used, the same effect can be obtained.

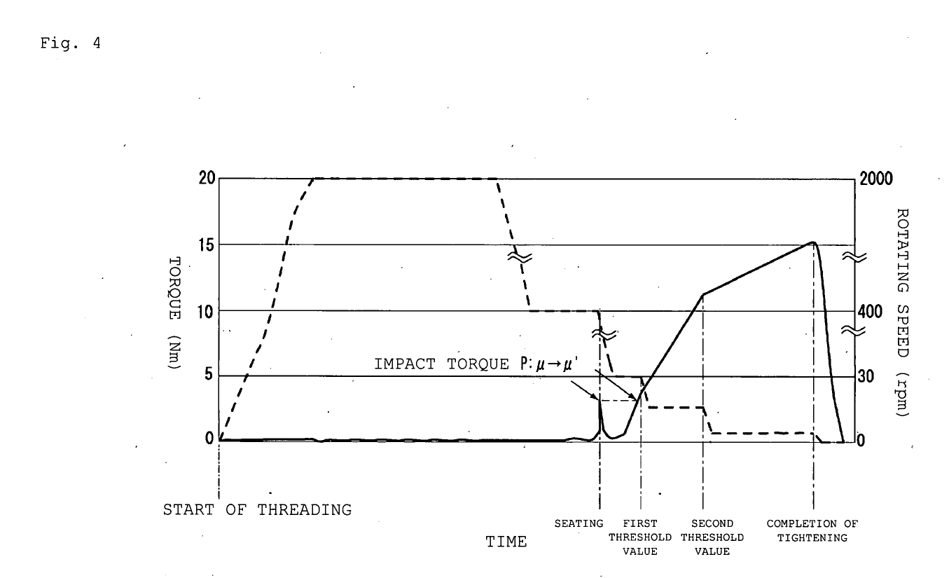

Next, the driving control of the threaded fastener tightening and loosening device 1 will be described with reference to FIG. 4.

FIG. 4 shows the driving control of the motor 3 by the control unit 18 of the threaded fastener tightening and loosening device 1, and is a graph showing the rotating speed of the output shaft 11 and torque in the “high speed tightening” process and the “high torque tightening” process. The start of threading to seating shows the “high speed tightening” process, and seating to the completion of tightening shows the “high torque tightening” process.

In the “high speed tightening” process, at the time of the start of threading, the control unit 18 driving controls the motor 3 so that the output shaft 11 is rotated at 2000 rpm which is the maximum rotating speed. Then, when the threaded fastener is threaded to a predetermined number of turns, the motor 3 is controlled so as to reduce the rotating speed of the output shaft 11 to a predetermined rotating speed.

Specifically, the number of turns of the threaded fastener is previously set into the memory section 18i of the control unit 18. Then, the rotation angle of the output shaft 11 is monitored by the resolver drive section 18d, the threaded fastener is threaded into the position in which two turns are subtracted from the number of turns necessary for the start of threading to seating, that is, to immediately before seating, and the motor 3 is driving controlled so as to reduce the rotating speed of the output shaft 11. The rotating speed of the output shaft 11 at the time of speed reduction is set to 400 rpm.

Then, after the speed is reduced to 400 rpm in the “high speed tightening” process, the threaded fastener is threaded by the remaining two turns and is seated, with the result that the impact torque is produced. When the impact torque is detected by the torque detection means, the control unit 18 electric current supply-controls the clutch control sections 18b and 18e to set the electromagnetic clutch 8 to OFF and to set the tooth clutch 14 to ON, and the motor 3 is reverse rotation-driven due to the harmonic drive characteristic. Thereby, the driving system is switched to the low speed high torque driving transmission system, so that the routine goes to the “high torque tightening” process.

In the “high torque tightening” process, a threshold value corresponding to rotation load torque which acts on the output shaft 11 is set into the memory section 18i of the control unit 18. A large threshold value and a small threshold value are set, a first threshold value having a low rotation load torque value is set to about 25% of the target tightening torque, and a second threshold value having a high rotation load torque value is set to about 75% of the target tightening torque. Then, each time rotation load torque reaches these threshold values, the control unit 18 driving controls the motor 3 so as to reduce the rotating speed of the output shaft 11.

For instance, when the target tightening torque is set to 15 N·m, the first threshold value is set to 3.75 N·m corresponding to 25% of the target tightening torque and the second threshold value is set to 11.25 N·m corresponding to 75% of the target tightening torque. In addition, the rotating speed of the output shaft 11 is set to 30 rpm from seating to the first threshold value, is set to 15 rpm from the first threshold value to the second threshold value, and is set to 3 rpm from the second threshold value to the target tightening torque.

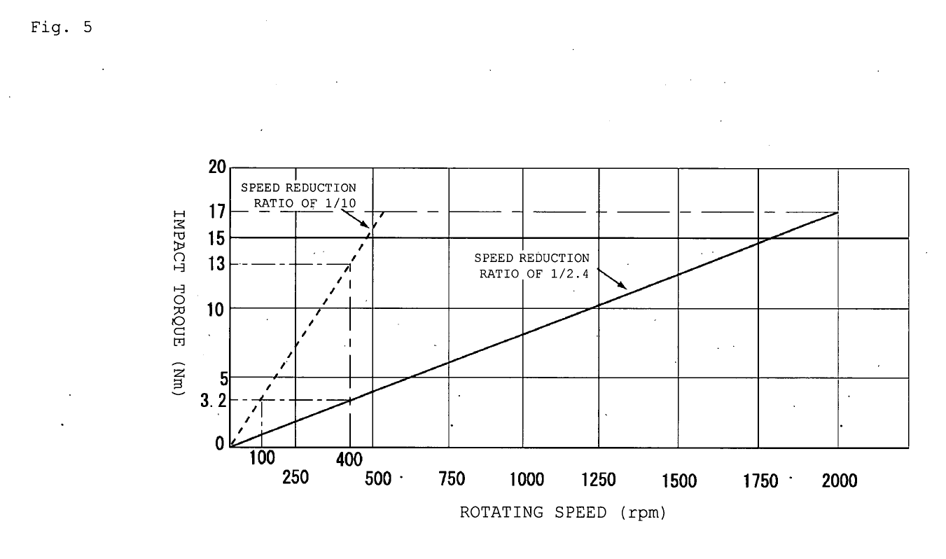

Here, FIG. 5 is a graph which compares the relation between the rotating speed of the output shaft 11 and the magnitude of the impact torque by speed reduction ratio. The solid line indicates the threaded fastener tightening and loosening device 1 of the present invention in which a speed reduction ratio is set to 1/2.4 by the pulleys 4 and 6 having a different number of teeth, and the dashed line indicates the threaded fastener tightening and loosening device for comparison in which the driving is transmitted via the speed reduction device having a speed reduction ratio of 1/10.

According to the graph shown in FIG. 5, in the threaded fastener tightening and loosening device 1 of the present invention, when the rotating speed of the output shaft 11 is 400 rpm, the impact torque of 3.2 N·m is caused. On the contrary, the rotating speed of the output shaft 11 is 2000 rpm, the impact torque of 17 N·m is caused. That is, when the threaded fastener is seated while the rotating speed of the output shaft 11 remains at 2000 rpm without being reduced to 400 rpm, the impact torque exceeds the target tightening torque of 15 N·m, resulting in excessive tightening.

On the contrary, in the threaded fastener tightening and loosening device for comparison, even when the rotating speed of the output shaft is reduced to 400 rpm like the threaded fastener tightening and loosening device 1 of the present invention, the impact torque which is as high as 13 N·m is caused by the high torque driving due to speed reduction. Here, when the impact torque is reduced to 3.2 N·m like the threaded fastener tightening and loosening device 1 of the present invention, the rotating speed of the output shaft is required to be reduced to 100 rpm. This cannot achieve the high speed tightening.

Accordingly, in the threaded fastener tightening and loosening device 1 of the present invention, the rotating speed of the output shaft 11 is reduced immediately before the threaded fastener is seated, so that no excessive impact torque is caused. For this reason, the threaded fastener cannot be tightened to the tightening torque by the impact torque. Therefore, excessive tightening can be prevented, and the tightening of the threaded fastener can be completed with the target torque. In addition, the impact torque can be low by the configuration in which the high speed low torque, driving transmission system driven in the “high speed tightening” process is not via the speed reduction device. Therefore, as compared with the threaded fastener tightening and loosening device for comparison, the rotating speed of the output shaft 11 can be set to be high and 400 rpm even at the time of speed reduction, so that high speed tightening can be realized.

In addition, the reduction of the impact torque can prevent the threaded fastener from being tightened to close to the threaded fastener tightening completion torque in the “high speed tightening” process. Therefore, as shown in FIG. 4, with respect to the friction between the seating surface of the threaded fastener and the tightened object, a moving point P from static friction μ to dynamic friction μ′ is at the stage before the “high torque tightening” process. Therefore, excessive tightening due to inertial moment caused at the time of moving from the static friction to the dynamic friction can be prevented.

Further, in the threaded fastener tightening and loosening device 1 of the present invention, the rotating speed of the output shaft 11 is reduced stepwise in the “high torque tightening” process. As described above, desirably, two or more large and small threshold values are set to perform speed reduction each time the rotation load torque reaches the threshold values. That is, when two threshold values are set, speed reduction control at three stages of high speed, intermediate speed, and low speed is performed. On the contrary, in the speed reduction control at two stages from high speed to low speed, excessive tightening can be caused by inertial moment at the time of speed reduction. Accordingly, in the speed reduction control at three stages, excessive tightening due to inertial moment at the time of speed reduction can be prevented via the intermediate speed stage, so that threaded fastener tightening is enabled at higher speed and with higher precision.

### DESCRIPTION OF REFERENCE SIGNS

1 Threaded fastener tightening and loosening device
2 Case
3 AC servo motor
4 Driving toothed pulley
5 First input shaft
6 Driven toothed pulley
7 Toothed belt
8 Electromagnetic clutch
9 Second input shaft
11 Output shaft
12 Speed reduction device
13 Coupling
14 Tooth clutch
15 Elastic body
16 Strain gauge
17 Attaching flange
18 Control unit
18a Control section
18b Clutch control section
18c Motor drive section
18d Resolver drive section
18e Clutch control section
18f Torque detection section
18g Operation section
18h Display section
18i Memory section

1. A threaded fastener tightening and loosening device comprising:
a first input shaft which is rotated by being driven by a rotation drive source;
a second input shaft which is rotatably provided;
first clutch means which makes a switch between a state where the driving of the rotation drive source can be transmitted to both the first input shaft and the second input shaft and a state where the driving of the rotation drive source cannot be transmitted to the second input shaft;
a speed reduction device which is connected to the first input shaft and can speed-reduce and output the rotation of the first input shaft at a predetermined speed reduction ratio;
an output shaft to which a threaded fastener tightening tool engageable with a head of a threaded fastener is connected and which is rotatable by being rotated by the second input shaft;
second clutch means which makes a switch between a state where the output rotation of the speed reduction device can be transmitted to the output shaft and a state where the output rotation of the speed reduction device cannot be transmitted to the output shaft; and
a control unit which controls the first clutch means and the second clutch means so that the rotation transmission state according to the first clutch means and the second clutch means becomes a predetermined rotation transmission state in each of a tightening process and a loosening process of the threaded fastener.

2. The threaded fastener tightening and loosening device according to claim 1, wherein
the control unit controls the first clutch to a state where the driving of the rotation drive source can be transmitted to the second input shaft and controls the second clutch to a state where the output rotation of the speed reduction device cannot be transmitted to the output shaft in the process of tightening the threaded fastener at high speed and in the process of loosening the threaded fastener at high speed.

3. The threaded fastener tightening and loosening device according to claim 1 or 2, wherein
the control unit controls the first clutch to a state where the driving of the rotation drive source cannot be transmitted to the second input shaft and controls the second clutch means to a state where the output rotation of the speed reduction device can be transmitted to the output shaft in the process of tightening the threaded fastener with high torque and in the process of loosening the threaded fastener with high torque.

4. The threaded fastener tightening and loosening device according to any one of claims 1 to 3, wherein
the control unit controls the rotation drive source to reduce the rotating speed of the output shaft to a predetermined rotating speed immediately before the threaded fastener is seated.

5. The threaded fastener tightening and loosening device according to any one of claims 1 to 4, wherein
the control unit controls the rotation drive source to reduce the rotating speed of the output shaft stepwise and non-stepwise from the seating of the threaded fastener to the completion of tightening.

6. The threaded fastener tightening and loosening device according to any one of claims 1 to 5, wherein
the speed reduction device is a harmonic drive (registered trademark), the first input shaft is connected to a wave generator, and the second clutch means is provided so that an output from a flex spline is transmitted.

7. The threaded fastener tightening and loosening device according to any one of claims 1 to 6, wherein
each of the first clutch means and the second clutch means is an electromagnetic clutch having an input portion and an output portion which can be coupled and decoupled by an electromagnetic force.
